(19) United States
(12) Patent Application Publication
(10) Pub. No.: US 2024/0315259 A1
(43) Pub. Date: Sep. 26, 2024

(54) USE OF EXTRACTS OF DISTILLERS' DRIED GRAINS WITH SOLUBLES AS BIOPESTICIDES AND/OR BIOSTIMULANTS

(71) Applicants: Universiteit Gent, Gent (BE); Katholieke Universiteit Leuven, Leuven (BE)

(72) Inventors: Danny GEELEN, Gent (BE); Bruno CAMMUE, Alsemberg (BE); Geert HAESAERT, Melle (BE); Tina KYNDT, Gent (BE)

(21) Appl. No.: 18/272,752

(22) PCT Filed: Jan. 20, 2022
(86) PCT No.: PCT/EP2022/051194

§ 371 Date: Jul. 17, 2023

(30) Foreign Application Priority Data
Jan. 20, 2021 (EP) 21152489.7

(51) Int. Cl. A01N 65/44; A01P 1/00; A01P 3/00; A01P 5/00; B01D 11/02; C12F 3/00

(52) U.S. Cl. CPC A01N 65/44; A01P 1/00; A01P 3/00; A01P 5/00; B01D 11/0288; C12F 3/00

(57) ABSTRACT

The present invention relates to the use of a Distillers' Dried Grains with Solubles (DDGS) as a biopesticide and/or biostimulant in agriculture.

### FIELD OF THE INVENTION

The present invention relates to the field of plant extracts, more specifically, the present invention pertains to a method for the preparation of a Distillers' Dried Grains with Solubles (DDGS) extracts, the extracts obtained thereof and the use of said extracts as a biopesticide and/or biostimulant in agriculture.

### BACKGROUND TO THE INVENTION

The present invention pertains to biostimulants. A biostimulant is a product whose function is to stimulate plant nutrition processes independently of the nutrient content of said product. On the contrary, a fertilizer is a product of natural or synthetic origin to be applied to soil or to plant tissues to supply one or more plant nutrients essential to the growth of plants.

Maize (Zea mays L.) (also known as corn) is a crop mainly used for human and animal nutrition. However, in recent decades, the production of bioethanol, a source of energy of renewable nature, has expanded the purpose of maize cultivation. Bioethanol production from maize leads to distillers' dried grains with solubles (DDGS), a carbohydrate, lipid, and protein rich coproduct, which has long been marketed as a source of high-quality protein for animal feed. DDGS can also be made from distillation of other grains. The relatively limited economic impact of DDGS on the feed market, due to competition with soybean-based feed, in addition to the market oversaturation, generated by the growing demands for bioethanol production, creates a need to explore for new strategies to exploit and valorize this coproduct, other than that of animal feed.

In order to be in line with the current trends to promote circular economy, which aims at putting waste, or less profitable coproducts back into the value chain, this bioethanol byproduct, e.g. from maize, imperatively needs alternative routes to recycle, reuse and upgrade.

The use of cereals such as maize in nutrition and bioethanol production depends on its yield, largely threatened by the numerous biotic and abiotic stresses that affect their production. In order to avoid an increase in agricultural land use (and its negative impact on climate change) and an excessive use of chemical fertilizers and pesticides (and its negative consequences on the environment and human well-being), new eco-friendly products need to be discovered.

In a world increasingly concerned with the environmental impact of the chemicals included in plant protection products and fertilizers, there is a growing need for natural alternatives, that could possibly one day replace synthetic agrochemicals. Therefore, in light of environmental concerns, biostimulants and biopesticides should be developed.

US2005229663 discloses a method for the use of dried distiller's grain and soluble as an herbicide and a fertilizer in the use of crop production wherein the DDGS is applied to the soil, serving both an herbicide function and a fertilizer function. A drawback is that DDGS are rather heterogenous in composition, and direct application does not guarantee good crop performance.

WO2012/015454 discloses organic biostimulant compositions, such as formulations comprising corn steep liquor (CSL) and water. Corn steep liquor (CSL) is a liquid by-product of the corn wet-milling process used to obtain corn starch and high fructose corn syrup (HFCS). CSL consists of concentrated corn solubles extracted during a process whereby corn, after having been shelled and air-cleaned, is soaked in water (steeped), and then fractionated into its principal components by a combination of flotation and wet screening procedures. A drawback of the present prior art is that CSL is a viscous product that is difficult to dose. In WO2012/015454 a biostimulant product is prepared by mixing CSL, water and microorganisms. This product has biostimulant properties not only when applied, but also on the microorganisms that are part of the composition of the product. Further, CLS is a coproduct of wet milling bioethanol production products, which wet milling process is used to produce bioethanol only in 10% of the total global bioethanol production. Therefore, a first drawback of the WO2012/015454 is that it uses microorganisms, more complex to manage, and a second drawback is that uses CSL, bioproduct of a niche bioethanol production process, resulting then in less material recycling.

WO2016/149033 relates to co-products of the ethanol biorefining process, more specifically dried grains (DDG) and distillers dried grains with solubles (DDGS). In particular, WO2016/149033 describes that commercially valuable amounts of oil can be extracted from the DDG and/or DDGS using a solvent extraction process, which can be further processed to provide valuable co-products, such as that disclosed in U.S. Pat. No. 8,227,015, US2012/0294977 and US2013/021688. Further, it is discussed that solvent extraction of DDG and DDGS according to the methods described therein may facilitate a reduction in the effective costs of producing ethanol from a grain-based biorefinery, as it allows for production of multiple, commercially valuable products from DDG and DDGS. For instance, the DDG and/or DDGS that undergo the solvent extraction process of WO2016/149033 can provide valuable products, such as animal feed supplements, herbicides and/or fertilizers. WO2016/149033 describes that solvent extraction processes suitable for extraction of crude oil from DDGS include processes that utilize ethanol, hexane, iso-hexane, petroleum distillate, mixtures thereof, or one or more other suitable solvents, as known in the art, for oil extraction of DDGS. Drawback of WO2016/149033 is that the de-oiled DDGS is used and no data concerning the antifungal/or antimicrobial properties of it are mentioned.

In the prior art, DDGS extracts are known to be used as fertilizers. It is an objective of the present invention to provide extracts of DDGS and uses thereof as a biopesticide and/or biostimulant, especially the latter, as well as method for providing said extracts.

### SUMMARY OF THE INVENTION

The present invention provides extracts of Distillers' dried grains with solubles (DDGS), a coproduct from bioethanol production chain e.g. from maize, currently in particular used and commercialized for animal feed. The inventors have found that aqueous extracts and organic solvent extracts prepared from DDGS are effective biopesticides. Further, the extracts provided have the beneficial effect of being biostimulants. Even further, the present invention provides a method of preparation of said extracts and uses thereof. It has been found that extracts according to the present invention provide for increased resistance to pathogens. It has furthermore been demonstrated that the extracts of the invention improve plant growth, crop quality and/or root growth, in particular adventitious and/or junction root growth.

In particular, in a first aspect the present invention provides a method for the preparation of a Distillers' Dried Grains with Solubles (DDGS) extract, comprising an aqueous extraction step comprising the steps of:
a) providing DDGS;
b) mixing the DDGS of step a) with an aqueous solution, while heating said mixture;
c) separating the heated mixture of step b) into a solid phase and a liquid phase; and
d) obtaining the liquid phase of step c) as a DDGS aqueous extract.

In accordance with an embodiment of the present invention, the solid phase obtained in step c) is further processed by:
a) mixing said solid phase with an organic extractant;
b) separating the mixture of step a) into a solid phase and a liquid phase; and
c) obtaining the liquid phase as a DDGS organic solvent extract;
wherein optionally steps a) to c) are repeated one or more times using a different extractant.

In accordance with a further embodiment of the present invention, said organic extractant is selected from the list comprising ethanol, ethyl acetate and hexane.

In accordance with yet another embodiment of the present invention, the steps a) to c) of the further processing on the solid phase are sequentially repeated using the following organic solvent extractants in the specified order: ethanol, ethyl acetate and hexane.

In accordance with a further embodiment of the present invention, the solid phase obtained in step c) is further processed by:
a) mixing said solid phase with ethanol;
b) separating the mixture of step a) into a solid phase and a liquid phase; and
c) obtaining the liquid phase as a DDGS ethanol extract.

In accordance with a further embodiment of the present invention, the solid phase obtained in step b) of the ethanol extraction is further processed by:
a) mixing said solid phase with ethyl acetate;
b) separating the mixture of step a) into a solid phase and a liquid phase; and
c) obtaining the liquid phase as a DDGS ethyl acetate extract.

In accordance with a further embodiment of the present invention, the solid phase obtained in step b) of the ethyl acetate extraction is further processed by:
a) mixing said solid phase with hexane;
b) separating the mixture of step a) into a solid phase and a liquid phase; and
c) obtaining the liquid phase as a DDGS hexane extract.

In accordance with a further embodiment of the present invention, said DDGS aqueous extract or DDGS organic solvent extract is further subjected to an evaporation step.

In accordance with a further embodiment of the present invention, said heating performed onto the mixture obtained by mixing DDGS and an aqueous solution is performed at a temperature in a range from about 30° C. to about 120° C., preferably from 50° C. to 100° C., preferably from 60° C. to 90° C., more preferably at a temperature of about 80° C. and/or for a sustained period of time, in a range from about 5 min to about 180 min, preferably from 10 min to 150 min, preferably from 50 min to 130 min, more preferably about 120 min.

In accordance with a further embodiment of the present invention, said DDGS is provided in powder form.

In a second aspect, the present invention relates to DDGS extracts obtainable by applying the method described by anyone of the embodiments of the present invention.

In a third aspect, the present invention relates to the use of DDGS extracts obtainable by applying the method described by anyone of the embodiments of the present invention as a biopesticide and/or biostimulant, in particular in agriculture and/or horticulture and/or home gardening and/or arboriculture.

In a fourth aspect, the present invention relates to the use of a DDGS extract as a biopesticide and/or biostimulant in agriculture, horticulture, home gardening and/or arboriculture.

In accordance with a further embodiment, the present invention relates to the use of a DDGS extract wherein said DDGS extract is selected from the list comprising: a DDGS aqueous extract, a DDGS ethanol extract, a DDGS ethyl acetate extract and a DDGS hexane extract; preferably a DDGS aqueous extract or a DDGS ethanol extract.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard no attempt is made to show structural details of the invention in more detail than is necessary for a fundamental understanding of the invention. The description taken with the drawings making apparent to those skilled in the art how the several forms of the invention may be embodied in practice.

FIG. 1, also abbreviated as FIG. 1, is a schematic representation of the sequential extraction procedure according to an embodiment of the present invention, used in the preparation of DDGS extracts, more specifically a (sequential) aqueous extract (OH) at the top of the figure, and an hexane extract (HE), an ethyl acetate extract (EA), and an ethanol extract (EH), at the bottom of the figure.

FIG. 2, also abbreviated as FIG. 2, shows results of biopesticidal assays, more specifically results on the root application of DDGS extracts (OH, EH, EA, HE) and Trichoderma hamatum T382 control (Ref 2) in the pathosystem Arabidopsis thaliana-Botrytis cinerea. Disease severity was evaluated by measuring the lesion diameter in 12 plants.

FIG. 3, also abbreviated as FIG. 3, shows results of biopesticidal assays, more specifically results on the leaf application of DDGS extracts (OH, EH, EA, HE) and Trichoderma hamatum T382 control (Ref 2) in the pathosystem Arabidopsis thaliana-Hyaloperonospora arabidopsidis. Disease severity was evaluated by quantifying the amount of newly produced pathogen spores on batches of 15 plants. Bars represent average spore formation of 7 batches.

FIG. 4, also abbreviated as FIG. 4, shows results of fungicidal activity assays, more specifically it shows biocontrol activity of DDGS extracts (OH, EH, EA, HE), a control (no extract added) and reference fungicidal compound (Fun) on three different plant-pathogen systems: Wheat/Blumeria graminis; Tomato/Alternaria solani; and potato/Phytophthora infestans. Data represent the average of three biological replicates. Error bars represent standard error. Asterisks indicate significant differences between control and treatment according to a Student's t-test (*P<0.05; ** P<0.01; *** P<0,001 **** P<0.0001; ns P>0.05). Reference fungicidal compounds: epoxiconazole, fenpropimorph, metrafenone, and chlorothalonil were used on the wheat assay; dithane on the tomato assay; and dithane on the potato assay.

FIG. 5, also abbreviated as FIG. 5, illustrates rice systemic defence activation against root-knot nematodes after foliar application of DDGS extracts. Inoculation with 250 second stage juveniles of root-knot nematode Meloidogyne graminicola on the root system was done at 24 h after foliar application of the 4 DDGS extracts, of a nematicide (Vert: Vertimec™), or water control. Data was taken 2 weeks later and scored as number of galls per rice plant. Data represent the average of a minimum of six biological replicates. Error bars represent standard error. Asterisks indicate significant differences between control and treatment according to a Student's t-test (*P<0.05; ** P<0.01; *** P<0.001; **** P<0.0001; ns P>0.05).

FIG. 6, also abbreviated as FIG. 6, illustrates in vitro growth inhibition of root-knot (Meloidogyne graminicola) and migratory (Pratylenchus zeae) nematodes by the 4 DDGS extracts (OH, EH, EA, HE), and by a commercial nematicide (Vertimec™: Vert). Each extract was tested at 3 different dilutions (0.1, 0.01, and 0,001). Top panel (Meloidogyne graminicola) represents the nematicidal effects of dilution 0.01 and the bottom panel (Pratylenchus zeae) represents the nematicidal effects of dilution 0.1.

FIG. 7, also abbreviated as FIG. 7, shows biostimulant assays, more specifically the adventitious roots numbers of Arabidopsis seedlings treated with water (Control) or with 3 different doses of the 4 extracts (OH, EH, EA, HE). Data represent the average of three biological and ten technical replicates per bar (30 seedlings in total, 10 per replicate). Error bars represent standard error. Asterisks indicate significant differences between control and treatment according to a Student's t-test (*P<0.05; ** P<0.01; *** P<0.001; ns P>0.05). OH: aqueous extract, EH: ethanol extract, EA: ethyl acetate extract, HE: hexane extract.

FIG. 8, also abbreviated as FIG. 8, shows biostimulant assays, more specifically junction roots numbers of Arabidopsis seedlings treated with water (Control) or with 3 different doses of the 4 extracts (OH, EH, EA, HE). Data represent the average of three biological and ten technical replicates per bar (30 seedlings in total, 10 per replicate). Error bars represent standard error. Asterisks indicate significant differences between control and treatment according to a Student's t-test (*P<0.05; ** P<0.01; *** P<0.001; **** P<0.0001; ns P>0.05). OH: aqueous extract, EH: ethanol extract, EA: ethyl acetate extract, HE: hexane extract.

FIG. 9, also abbreviated as FIG. 9, shows percentage of normal size pollen from Arabidopsis plants treated with water (Control), with a commercial biostimulant (Kelpak™), or with 3 different doses (0.1; 0.01; 0.001) of the 4 extracts (OH, EH, EA, HE). OH: aqueous extract, EH: ethanol extract, EA: ethyl acetate extract, HE: hexane extract.

FIG. 10, also abbreviated as FIG. 10, shows chlorophyll content (left panel) and growth rate (right panel) during week 2 (W2) of maize plants, treated with water (control) or with the DDGS aqueous (OH) extract at a concentration of 10%. Data represent the average of 3 (control) or 4 (OH) biological replicates. Error bars represent standard error. Asterisks indicate significant differences between control and treatment according to a Student's t-test (*P<0.05; ** P<0.01; *** P<0.001; **** P<0.0001; ns P>0.05).

FIG. 11, also abbreviated as FIG. 11, shows tomato growth rate (top panel) and wheat height (bottom panel) treated with water (control) or with the DDGS extracts (OH, EH, EA, HE) extracts. Data represent the average of three biological replicates. Error bars represent standard error. Asterisks indicate significant differences between control and treatment according to a Student's t-test (*P<0.05; ** P<0.01; *** P<0.001; **** P<0.0001; ns P>0.05).

### DETAILED DESCRIPTION OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. When describing the compounds of the invention, the terms used are to be construed in accordance with the following definitions, unless a context dictates otherwise.

The term “about” or “approximately” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” or “approximately” refers is itself also specifically, and preferably, disclosed.

As used in the specification and the appended claims, the singular forms “a”, “an”, and “the” include plural referents unless the context clearly dictates otherwise. By way of example, “an extract” means one extract or more than one extract.

In particular, in a first aspect the present invention provides a method for the preparation of a Distillers' Dried Grains with Solubles (DDGS) extract.

The present invention provides extracts of Distillers' dried grains with solubles (DDGS), a coproduct from the bioethanol production chain e.g. from maize, currently in particular used and commercialized for animal feed. The inventors have found that aqueous extracts and organic solvent extracts prepared from DDGS are effective biopesticides. Further, the extracts provided have the beneficial effect of being biostimulants. Even further, the present invention provides a method of preparation of said extracts and uses thereof. It has been found that extracts according to the present invention provide for increased resistance to pathogens. It has furthermore been demonstrated that the extracts of the invention improve plant growth, crop quality and/or root growth, in particular adventitious and/or junction root growth.

In accordance with the present invention, by means of the term “Distillers' Dried Grains with Solubles” or “DDGS”, reference is made to a cereal byproduct of the distillation of grains. DDGS is for example a coproduct from the maize bioethanol production. Wet distillers' grains (WDG) contain primarily unfermented grain residues (protein, fiber, fat and up to 70% moisture). Dried distillers' grains with solubles (DDGS) is WDG that has been dried with the concentrated thin stillage to 10-12% moisture.

In accordance with a specific embodiment of the present invention, the DDGS is a maize bioethanol coproduct.

By means of the term “DDGS extract”, reference is made to an extract obtained from DDGS. Such extract is obtained by means of an extraction process which is a separation process comprising the separation of substances (e.g. active agents) from a matrix (i.e. DDGS).

As example, it is hereby described a method of production of DDGS from a maize harvest. First, after harvesting, the maize harvest goes through a process of grains milling, wherein maize grains are milled. Then the step of liquefaction comprises adding water to the milled grains, which are subsequently left fermenting. The fermented mixture is then distilled causing formation of bioethanol and DDGS as a coproduct.

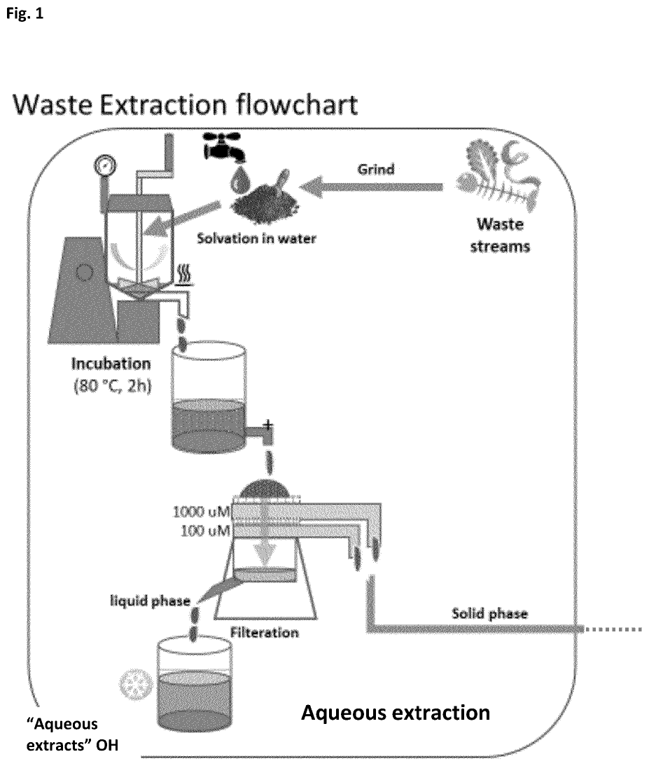

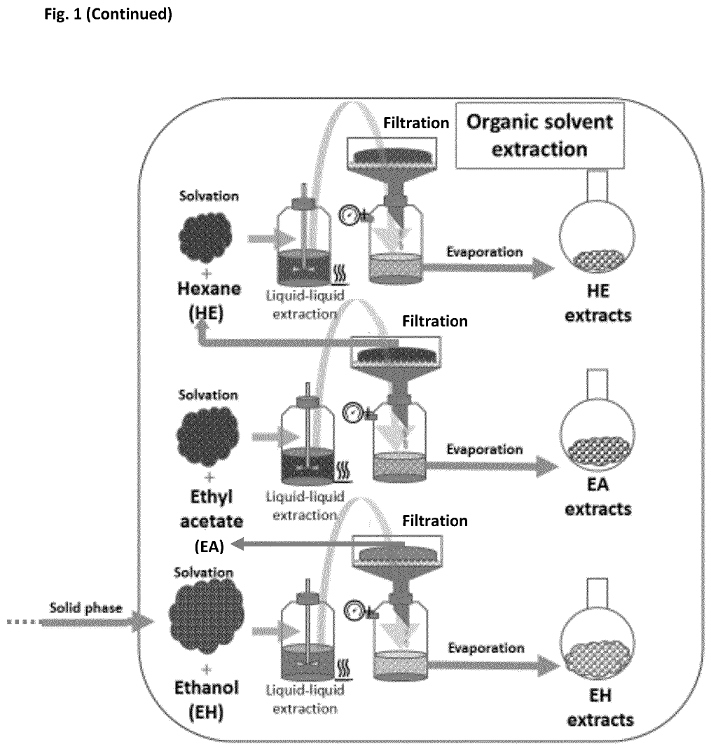

FIG. 1. exemplifies an embodiment of the present invention, wherein at the top of the figure, an aqueous extraction process is illustrated, whilst at the bottom, extraction from DDGS with an organic extractant is illustrated. More specifically, FIG. 1 is a schematic representation of the sequential extraction procedure according to an embodiment of the present invention, used in the preparation of DDGS extracts, more specifically a (sequential) aqueous extract (OH) at the top of the figure, and a hexane extract (HE), an ethyl acetate extract (EA), and an ethanol extract (EH), at the bottom of the figure.

The method of the present invention for the preparation of a DDGS extract comprises an aqueous extraction step comprising the steps of:
a) providing DDGS;
b) mixing the DDGS of step a) with an aqueous solution, while heating said mixture;
c) separating the heated mixture of step b) into a solid phase and a liquid phase; and
d) obtaining the liquid phase of step c) as a DDGS aqueous extract (OH).

At step a), the DDGS can be provided in various forms, such as in the form of pellets, granules, powder or larger conglomerates, powder form is preferred. In the context of the present invention, the term “powder” is meant to be fine, dry particles produced by the grinding, crushing or disintegration of a solid substance.

At step b), the DDGS is mixed with an aqueous solution, which can be water, such as distilled water. The aqueous solution can be a saline solution, or a solution with other salts dissolved therein. The aqueous solution is preferably water. The ratio DDGS: aqueous solution of the obtained mixture can be variable. For example, in accordance with an embodiment of the present invention, the ratio of DDGS (kg):aqueous solution (L) is in the range of from 0.5:5 to 5:5, in particular from 1:5 to 4:5, more in particular about 1:5. Heating has the advantage that the extraction is accelerated. The aqueous solution penetrates faster into the plant tissue, allowing the solubility of most compounds to be higher, further, it has the advantage of killing most microbes which helps to protect the obtained extract from degradation.

In accordance with an embodiment of the present invention, the mixing of DDGS with the aqueous solution is performed while heating the mixture comprising the aqueous solution and DDGS.

In accordance with a further embodiment of the present invention, the step of heating the mixture obtained by mixing DDGS and an aqueous solution is performed at a temperature in a range from about 30° C. to about 120° C., preferably from 50° C. to 100° C., preferably from 60° C. to 90° C., more preferably at a temperature of about 80° C. and/or for a sustained period of time, in a range from about 5 min to about 180 min, preferably from 10 min to 150 min, preferably from 50 min to 130 min, more preferably about 120 min.

In accordance with a further specific embodiment of the present invention, the step of heating the mixture obtained by mixing DDGS and an aqueous solution is performed at a temperature of about 80° C. and for a period of time of about 120 min.

A person skilled in the art is able to determine the ideal time and temperature in order to obtain the most suitable extract for the intended applications. Moreover, similar bioactivity can be obtained by extracting a bit longer at lower temperature, or a bit shorter at higher temperature.

In accordance with a preferred embodiment of the present invention, said heating is performed for about 2 h at about 80° C.

As also illustrated in FIG. 1, in order to provide for a solid phase after aqueous extraction, at step c) the mixture is filtrated or sieved. Several different techniques can be used to separate the solid phase from the liquid phase after aqueous extraction.

In accordance with a further embodiment of the present invention, the solid phase obtained in step c) is further processed by:
a) mixing said solid phase with an organic extractant; the organic extractant is an organic solvent or organic agent to solubilize components in the DDGS;
b) separating the mixture of step a) into a solid phase and a liquid phase; and
c) obtaining the liquid phase as a DDGS organic solvent extract;
wherein optionally steps a) to c) are repeated one or more times using a different extractant.

In accordance with a further embodiment of the present invention, said organic extractant is selected from the list comprising ethanol, ethyl acetate and hexane.

Therefore, in accordance with an embodiment of the present invention, after the DDGS aqueous extract (OH) is obtained, the solid phase remaining is then subjected to three extractions steps with organic extractants, meaning ethanol (EH), ethyl acetate (EA) and hexane (HE).

In accordance with yet another embodiment of the present invention, the steps a) to c) of processing said solid phase are sequentially repeated using the following organic extractants in the specified order: ethanol, ethyl acetate and hexane.

More specifically, in accordance with a further embodiment of the present invention, the solid phase obtained in step c) in the aqueous extraction is further processed by:
a) mixing said solid phase with ethanol;
b) separating the mixture of step a) into a solid phase and a liquid phase; and
c) obtaining the liquid phase as a DDGS ethanol extract.

In accordance with a further embodiment of the present invention, the solid phase obtained in step b), after step a) of mixing the solid phase with ethanol, the solid phase is further processed by:
a) mixing said solid phase with ethyl acetate;
b) separating the mixture of step a) into a solid phase and a liquid phase; and
c) obtaining the liquid phase as a DDGS ethyl acetate extract.

In accordance with a further embodiment of the present invention, the solid phase obtained in step b), after step a) of mixing the solid phase with ethyl acetate, the solid phase is further processed by:
a) mixing said solid phase with hexane;
b) separating the mixture of step a) into a solid phase and a liquid phase; and
c) obtaining the liquid phase as a DDGS hexane extract.

In accordance with a further embodiment of the present invention, said DDGS organic solvent extract is further subjected to an evaporation step.

In a second aspect, the present invention relates to a DDGS extract obtainable by applying the method described by anyone of the embodiments of the present invention.

In a third aspect, the present invention relates to the use of a DDGS extract obtainable by applying the method described by anyone of the embodiments of the present invention as a biopesticide and/or plant biostimulant, in particular in agriculture. In accordance with the present invention, by means of the term “biopesticide”, reference is made to a pest management agent derived from natural sources.

Therefore, other than having biopesticide properties, the DDGS extracts according to the present invention have biostimulant properties. Any plant/crop can be treated. The term “plant (or plants)” is a synonym of the term “crop” which is to be understood as a plant of economic importance and/or a men-grown plant. The methods, extracts and compositions of the present invention may be applied to any plant, such as monocots, dicots, non-vascular (liverworts, mosses), ferns, gymnosperms, etc. The extract or a composition comprising the extract is applied to a plant, directly or indirectly. Any appropriate plant part can be treated or used including plant organs (e.g., leaves, stems, roots, etc.), seeds, and plant cells and progeny of the same. In the alternative, the extract or composition can be applied to the soil surrounding the plant, however with direct contact with the roots. The applying of the extract is prior to planting, at planting, or after planting. In one embodiment, contacting includes direct application to a plant. All or part of a plant including, without limitation, leaves, stems, roots, propagules (e.g., cuttings), fruit, seeds etc., may be contacted with the extract described herein. Contacting may also be carried out indirectly, via application, e.g., to soil or other plant substrates but making uptake by the plant possible.

In one embodiment, the extract of the present invention is used in a method of inducing (systemic) resistance to biotic stress in a plant. The method comprises applying the extract to the plant, after which systemic plant immunity will be activated. The applying step could be performed according to various embodiments. For instance, the plant extract or a composition comprising it could be sprayed on the plant, watered on the plant, added to the substrate, such as hydroponics, soil, peat, compost, vermiculite, perlite, sand or clay, in which the plant is growing, etc. In a particular embodiment there is no direct contact of the extract or composition with the pathogen or target organism. Hence, the current invention provides a method of treating or preventing, or at least inhibiting or alleviating, pathogen or pest damage in a plant, in particular through the activation of the plant defence mechanism. The plant extract is able to achieve this protecting effect in the whole plant even when sprayed only on a part of the plant, or when sprayed at relatively low concentrations, and without being directly toxic to said plant pathogen. Of particular advantage is that the present plant extract can be used pre-emptively (e.g. to seedlings or non-infected plants or plants having no visible signs of infection) and require only a simple formulation. The use as a priming agent will delay, or even prevent the damage to the plant when infected.

The present invention relates to methods and compositions which can be used to stimulate or induce plant defence and/or immune responses against plant pathogens such as against bacteria, fungi, nematodes and oomycetes, in particular against fungi, nematodes and/or oomycetes. In one embodiment, the invention provides a method for controlling plant pathogens, said method comprising applying on or to said plant the extract provided herein.

Examples of phytopathogenic bacteria include the genera Pseudomonas, Ralstonia, Rhizobium, Agrobacterium, Xanthomonas, Erwinia, Xylella, Dickeya, Pectobacterium, Streptomyces, Clavibacter, Candidatus Liberibacter, Bacillus, Corynebacterium and Burkholderia. Examples of phytopathogenic fungi (including biotrophic, hemi-biotrophic, necrotrophic fungi) include the genera Magnaporthe, Botrytis, Puccinia, Fusarium, Blumeria, Mycosphaerella, Colletotrichum, Ustilago, Phakopsora, Alternaria, Sclerotinia, Cladosporium and Rhizoctonia. In one embodiment, the invention provides a method to reduce and/or prevent infection of a plant with the phytopathogen Phytophthora infestans (late blight of potato), Botrytis cinerea (gray mold of tomato), Blumeria graminis (powdery mildew of wheat) and Alternaria alternata (leaf spot of tomato) and Alternaria solani. Examples of plant parasitic nematodes include “cyst nematodes” (genera Heterodera and Globodera) and “root-knot nematodes” (genus Meloidogyne). Examples of cyst nematodes include, H. schachtii (sugar beet cyst nematode), H. avenae (cereal cyst nematodes), H. glycines (soybean cyst nematode), H. sacchari (sugarcane cyst nematode), H. carotae (carrot cyst nematode), G. pallida (white potato cyst nematode) and G. rostochiensis (yellow potato cyst nematode). Root-knot nematodes include, for example, M. graminicola, M. javanica, M. incognita, M. arenaria, M. chitwoodi, M. artiellia, M. fallax, M. hapla, M. microtyla, M. partityla, M. panyuensis, M. naasi, M. exigua, M. enterolobii and M. paranaensis. Other nematodes that cause significant damage include the “root-lesion” nematodes such as Pratylenchus, particularly P. penetrans, which infects maize, rice and vegetables, P. brachyurus which infects pineapple, P. zeae, which infects cereals, sugarcande and coffee, P. coffeae, which infects coffee and banana, and P. thornei, which infects wheat. In one aspect, “plant parasitic nematodes” include microorganisms from the genera Meloidogyne, Heterodera, Globodera, Pratylenchus, Aphelenchoides, Xiphinema, Radopholus, Bursaphelenchus, Rotylenchulus, Nacobbus, Longidorus, Ditylenchus and Trichodorus, and in particular from the genera Meloidogyne, Heterodera and Pratylenchus. Examples of phytopathogenic oomycetes (formerly classified as fungi) are species of the genera Pythium, Phytophtora and Peronosporaceae (e.g. Hyaloperonospora), in particular Phytophtora and Hyaloperonospora.

In one embodiment, the invention provides a method to reduce and/or prevent infection of a plant with the phytopathogen Pratylenchus and/or Meloidogyne.

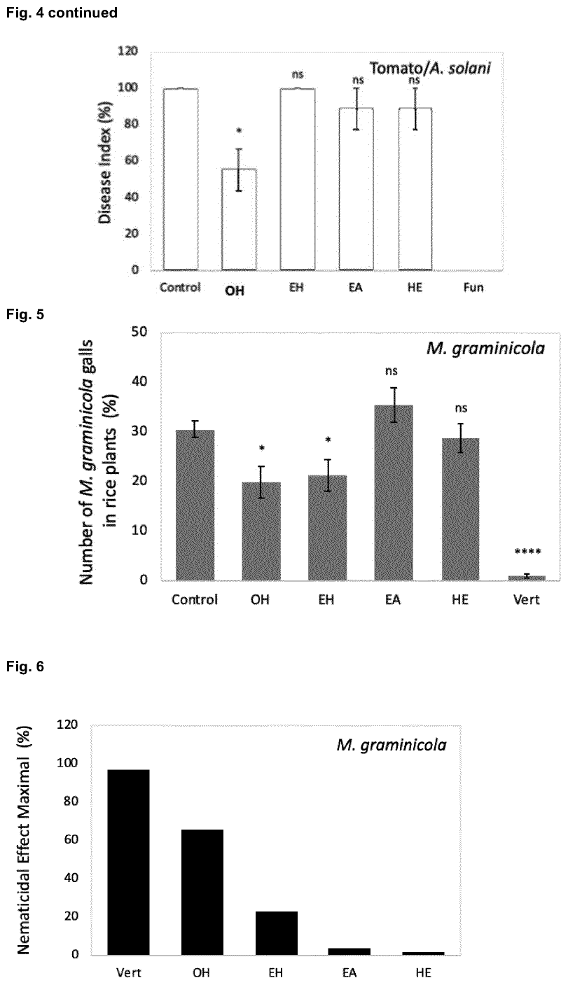

The biopesticidal effect is strong across all extracts, whereas the biostimulant effect may be dependent on the type of extract and the type of plant to be treated. For example, it has been seen that the EH extract has a particular biostimulant effect on tomato plants, whereas the OH and the HE extracts have a particular biostimulant effect on wheat, see FIG. 11. Accordingly, for example when treating tomato plants, only the OH extract was effective as biopesticide, whilst for wheat all the extracts were effective biopesticides, see FIG. 4, while EH extracts may be preferred for their bonus effect of biostimulation on tomato plants.

In the context of the present invention, the term biostimulant is meant to be any substance, composition or product whose function is to stimulate plant nutrition processes independently of its nutrient content with the sole aim of improving one or more of the following characteristics of the plant or the plant rhizosphere: (a) nutrient use efficiency, (b) tolerance to abiotic stress, (c) quality traits, or (d) availability of confined nutrients in the soil or rhizosphere.

Different tests may be used to determine the biostimulant effect on plants, such as height, growth rate, chlorophyll content, silique length, seed amount per silique, seed weight, surface area or percentage of normal size pollen, root growth, root length, root branch numbers, adventitious rooting, pollen viability . . . .

In one embodiment, the extract of the invention is used for modulating plant development and in particular for promoting growth of adventitious roots (including increase in AR root number) and/or junction roots, this when compared to untreated plants. Hence, the extract can be used as a biostimulant, more specific in a method to control plant development such as e.g. increasing the tolerance of plants to stress (e.g. drought stress, heat stress, cold stress, salt stress), or to control physiological phenomena such as pre-harvest sprouting and premature senescence. In certain embodiments, the plant with altered root morphology exhibits improved tolerance to stress conditions selected from the group consisting of drought, flooding, high salt growth conditions, extreme cold, and (extreme) heat, compared to the average tolerance of a statistically significant control population that has not been treated with the extract. The term ‘adventitious root growth’ refers to the expansion of the root biomass mediated by cell division and cell expansion in the adventitious root meristems.

In a fourth aspect, the present invention relates to the use of a DDGS extract as a biopesticide and/or plant biostimulant, in particular in agriculture, horticulture; home gardening and/or arboriculture.

In accordance with a further embodiment, the present invention relates to the use of a DDGS extract wherein said DDGS extract is selected from the list comprising: a DDGS aqueous extract, a DDGS ethanol extract, a DDGS ethyl acetate extract and a DDGS hexane extract; preferably a DDGS aqueous extract or a DDGS ethanol extract. Based on the results of biopesticide and/or biostimulant activity, the most interesting extracts in terms of activity are in order of relevance: DDGS aqueous extract, DDGS ethanol extract, DDGS ethyl acetate extract and DDGS hexane extract.

The present invention also encompasses (the use of) a composition or formulation comprising the extract of the invention. An “agrochemical composition” as used herein means a composition for agrochemical use, such as use in the agrochemical industry, including agriculture, horticulture, floriculture, arboriculture and home and garden uses for stimulating plant/root growth and/or for protecting plants or parts of plants, crops, bulbs, tubers, fruits (e.g. from harmful organisms, diseases or pests) as herein defined, comprising at least the extract as defined herein, and at least one agriculturally and/or horticulturally acceptable excipient. Typically, the extract of the invention may be administered to a plant in a suitable agriculturally acceptable formulation, including but not limited to, a growing medium such as soil or hydroponic liquid medium, dusts, granules, solution concentrates, emulsifiable concentrates and wettable powders. The term “agriculturally acceptable” indicates that the formulation is non-toxic and otherwise acceptable for application to a plant, whether applied indoors (e.g. in a contained environment) or outdoors (e.g. in a non-contained environment that is exposed to other plant, animal and human life).

In a further embodiment of the present invention, the extract or a composition comprising the extract is applied to a plant or tree, directly or indirectly. Any appropriate plant part can be treated or used including plant organs (e.g., leaves, stems, roots, etc.), seeds, and plant cells and progeny of the same. In the alternative, the extract or composition can be applied to the soil surrounding the plant, however with direct contact with the roots. The applying of the extract is prior to planting, at planting, or after planting. In one embodiment, contacting includes direct application to a plant. All or part of a plant including, without limitation, leaves, stems, roots, propagules (e.g., cuttings), fruit, seeds etc., may be contacted with the extract described herein. Contacting may also be carried out indirectly, via application, e.g., to soil or other plant substrates but making uptake by the plant possible. Suitable application methods include high or low-pressure spraying, immersion, atomizing, foaming, fogging, coating, and encrusting. Other suitable application procedures can be envisioned by those skilled in the art. In a particular embodiment, the extract of the invention is applied to the parts of the plant above ground or to the foliage of the plant by spraying e.g. by the use of mechanical sprayers. Sprayers convert a formulation of the invention which is mixed with a liquid carrier, such as water or fertilizer, into droplets. The droplets can be any size. Boom sprayers and air blast sprayers can also be used to apply formulations of the invention to pre-emerging or post-emerging crops. Air blast sprayers inject formulations of the invention mixed with a liquid carrier into a fast-moving air stream. Boom sprayers, aerial sprayers, ultra-low volume sprayers, drip irrigation, sprinkler irrigation, and foggers can also be used to apply formulations of the invention. Where the formulations of the invention are in a solid, powder or granule form, they can be applied with granule or dust application equipment. Formulations of the invention can also be applied as a fumigant to soil, plant media, plants, or plant tissues. In another embodiment, seeds of a plant are coated with the extract of the invention (“coated seeds”). Any appropriate seed coating method known the skilled person can be used.

In a specific embodiment, the extract of the present invention can be applied to a plant as provided herein alone, in combination or in a mixture with other compounds. Suitable other compounds include effective amounts of other agricultural or horticultural biologicals and/or chemicals, such as herbicides, insecticides, nematicides, molluscicides, bactericides, acaricides, fungicides, and/or plant growth regulators or fertilizers.

The following examples are set forth below to illustrate the methods, compositions, and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

### Examples

### Preparation of the Extracts

### Raw Material Pre-Processing Treatment

The dried material (distillers dried grains with solubles: DDGS) was collected from the supplier (AlcoBioFuel: https://www.alcobiofuel.com/biorefinery/), and ground (at the ILVO's Food Pilot) into a fine powder using vacuum cooking cutter.

### Extraction Procedure

Five kilograms of dried DDGS powder were mixed with 25 L of water. The resulting solid/water mixture (of approximately 30 L) was incubated for 2 h at 80° C. in a so called “Stephan's mixer cutter”. Solid and liquid phases are separated by passing the mixture through a vibrating sieve. The liquid phase obtained in this way constitutes the “aqueous (OH) extract”, which is aliquoted and frozen until further use. The resulting solid phase of the aqueous extraction is then subjected to three sequential organic solvents extractions: ethanol (EH), ethyl acetate (EA) and hexane (HE), see FIG. 1.

First, the solid material was mixed and incubated with ethanol. The solid/ethanol mixture was partitioned using a Buchner funnel. This procedure yielded the “liquid ethanol (EH) extract” and a new solid phase. The ethanol contained in the extract was evaporated to remove the solvent and stored as “dried ethanol (EH) extract”. The solid phase generated from the ethanol extraction went through an ethyl acetate (EA) extraction, and a subsequent hexane (HE) extraction, as described before. At the end of the whole extraction procedure, an aqueous extract (OH), and three solid solvent extracts (EH, EA, and HE) were obtained.

### Biopesticidal Activity

INDUCED RESISTANCE (IR) Pathosystem: Arabidopsis thaliana-Botrytis cinerea (Necrotrophic Fungal Pathogen)

### Materials and Methods

Arabidopsis thaliana Col 0 plants were grown in square petri dishes containing ½ MS medium with 8 g/L sucrose. After stratification (2 days on 4° C.) and sterilization (5 min in 30% bleach), six seeds were shown on the top of the solid medium, of which the upper part (⅓) was removed. Plates were sealed with Micropore™ Medical Tape (3M™, St. Paul, Minnesota, USA) and placed vertically in a growth chamber. After 21 days, the plants were treated with the candidate ISR-inducer. For the disease assay with B. cinerea, two leaves per plant were infected with 2 μL drops 5*105 spores/ml spore suspension of Botrytis cinerea B05.10 in ½ PDB buffer. The infection took place three days after inoculation. Disease symptoms were scored three days after infection by measuring the diameter of the necrotic lesions parallel to the midrib.

### Results

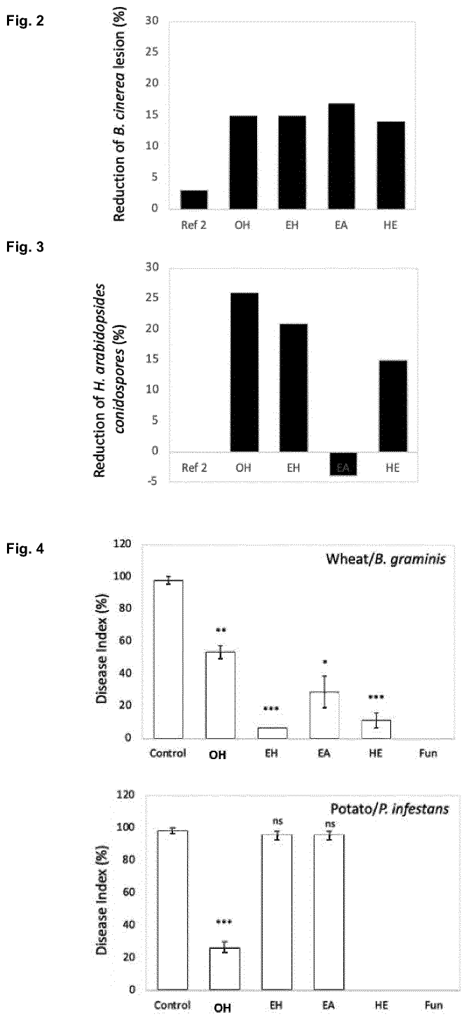

Application of all four (OH, EH, EA, HE) DDGS extracts resulted in a significant reduction of lesions caused by infection Botrytis cinerea when applied to the roots of Arabidopsis plants, see FIG. 2. FIG. 2 shows results of biopesticidal assays, more specifically results on the root application of DDGS extracts (OH, EH, EA, HE) and Trichoderma hamatum T382 control (Ref 2) in the pathosystem Arabidopsis-B.cinerea. Disease severity was evaluated by measuring the lesion diameter in 12 plants.

Since extract application and pathogen inoculation are done on different organs of the same plant, the observed reduction does not result from direct antagonistic (or direct) effect of the extracts on the pathogen, but from an induced resistance (IR) in the plant triggered by the DDGS extracts. All the extracts appear to be equally active.

INDUCED RESISTANCE (IR) Pathosystem: Arabidopsis thaliana-Hyaloperonospora arabidopsidis (Biotrophic Oomycete Pathogen)

### Materials and Methods

Arabidopsis plants (ecotype Col0) were grown in soil at a dark/light regime of 12 h/12 h, a light intensity of 100 μM, a temperature of 21° C. and relative humidity of 70%. Leaves of 8-days old plants were sprayed with the DDGS extracts (OH:100%, EH: 250 mg/mg, EA: 20 mg/ml, HE: 20 mg/ml) or distilled water (negative control) until run-off. One day later inoculation of the non-treated leaves was done by spraying the leaves until run-off with a spore suspension (5*104 spores/ml in H₂O) of Hyaloperonospora arabidopsidis Noks1. Plants were further grown for another 7 days under the same conditions as mentioned before (but at 17° C.), and in an incubation box allowing maximal relative humidity and favouring disease progression. Disease severity was evaluated by quantifying the amount of newly produced pathogen spores on batches of 15 plants. Bars represent average spore formation of 7 batches (each representing 15 plants).

### Results

Application of the DDGS aqueous (OH) ethanol (EH) and hexane (HE) extracts, resulted in a reduction of spore formation caused by infection of the oomycete Hyaloperonospora arabidopsidis when applied on leaves of Arabidopsis plants, see FIG. 3. The ethyl acetate (EA) extract had the opposite effect. FIG. 3 shows results of biopesticidal assays, more specifically results on the leaf application of DDGS extracts (OH, EH, EA, HE) and Trichoderma hamatum T382 control (Ref 2) in the pathosystem Arabidopsis-Hyaloperonospora arabidopsidis Disease severity was evaluated by quantifying the amount of newly produced pathogen spores on batches of 15 plants. Bars represent average spore formation of 7 batches.

### Fungicidal Activity

### Materials and Methods

The biocidal activity of DDGS extracts was tested against three important widespread plant pathogens: Phytophthora infestans (late blight of potato), Blumeria graminis (powdery mildew of wheat) and Altemaria solani (of tomato).

### Detached Leaf Assay

Detached leaf assay of 6-7 weeks-old tomato and potato was used for pathogens: A. solani and P. infestans respectively. Foliar spraying of tomato and potato plants with the DDDG extracts was done 24 h before inoculation, in order to take protective mode of action into account. Control plants were treated with water (negative control), with 5330 mg/l Mancozeb (Dithane, tomato positive control), or with 160 g/l Ranman-Top® (Dithane, potato positive control).

After spraying, leaves were removed (3 compound leaves per replicate) and inoculated with a single (15 μL) droplet of spore suspension of pathogens (105 spore/ml). Leaflet were kept under appropriate incubation conditions, in a plant growth chamber. Disease incidence was assessed 5-7 days after inoculation, on treated and control leaflets according to an arbitrary grading scale and by converting to disease severity index (DSI), on a percentage basis.

$$DSI ( \% ) = \frac{\sum ( class frequency \times score of rating class )}{( total number of leaflets ) \times ( maximal rating class )} \times 100$$

To quantify the disease severity over time, the area under the disease progress curve (AUDPC) was calculated for potato plants during 32 days of infection according to the equation: AUDCP=Σ[(Xi+Xi+1)/2]ti. Where Xi and Xi+1 are severity on date i and date i+1, respectively, and ti is the number of days between date i and date i+1.

### Whole Plant Assay

Whole plant assay of wheat was used for pathogen: B. graminis on wheat. Foliar spraying of 2 weeks-old wheat plants with DDGS extracts was done 24 h before inoculation in order to take protective mode of action into account. Control plants were treated with water (negative control), or with a mixture of: epoxiconazole+fenpropimorph+metrafenone+chlorothalonil: 100 g+320 g+120 g+500 g/ha (positive control).

Sprayed whole plants were inoculated by spraying spore suspension of B. graminis (105 spore/ml) and kept under appropriate conditions in the greenhouse. Disease intensity was assessed on the bases of disease symptoms (pathogen white flecks) and the severity is calculated 20 days after inoculation as described above.

### Results

Application of all the DDGS extracts resulted in a significant reduction (50 and up to 90%) of disease symptoms caused by infection of the B. graminis when applied on wheat plants, see FIG. 4. More specifically, FIG. 4 shows results of fungicidal activity assays, more specifically it shows biocontrol activity of DDGS extracts (OH, EH, EA, HE), a control (no extract added) and reference fungicidal compound (Fun) on three different plant-pathogen systems: Wheat/B. graminis; Tomato/A. solani; and potato/P.infestans. Data represent the average of three biological replicates. Error bars represent standard error. Asterisks indicate significant differences between control and treatment according to a Student's t-test (*P<0.05; ** P<0.01; *** P<0.001; **** P<0.0001; ns P>0.05).

For tomato and potato only the OH extract was effective at significantly reducing the disease symptoms caused by A. solani and P. infestans respectively, see FIG. 4. Please note that for the pathosystem potato/P.infestans the HE extract was not tested.

### Induced Resistance to Nematodes

### Materials and Methods

### Induced Resistance on Rice

Nematode cultures: Root-knot nematode Meloidogyne graminicola was extracted from infected Echinocloa crus-galli roots grown in potting soil at 25° C. Roots were washed until most soil was removed, after which they were cut into short fragments (with special care taken to cut open any visible root galls). The cut material was put in 200 μm pore diameter sieves which were put into a tap water bath at room temperature for three days. The water was then poured over a 20 μm mesh sieve to collect the nematodes. The sieve surface was washed with approximately 50 ml of non-demineralized water, which was collected into a beaker before it could seep through the sieve. The number of J2 (second stage juvenile) nematodes in five 100 μl samples taken from the nematode suspension was counted under a stereo microscope and averaged to determine inoculum concentration.

Rice (Oryza sativa) growth: Seeds (cultivar ‘Nipponbare’) were germinated on wet tissue paper at 30° C. in the dark for three days, followed by transfer to individual PVC tubes containing SAP, see Reversat et al., 1999. SAP (sand-absorbent polymer) is a mixture of fine silica sand and ultra-absorbent acrylic copolymer (AquaPerla™, DCM, Grobbendonk, Belgium) in a ratio of 1 kg sand to 1.5 g of dry copolymer.

Before use, each tube was washed in soapy water and dried in an oven at 70° C. for two days. The tubes were placed inside plastic boxes in a completely randomized manner to minimize environmentally induced bias and transferred to a growth chamber at 28° C. with 16 hours of light. The first two days after transfer, the tubes were covered with a polyethylene film (Saran Film™, Dow Chemicals, Midland, USA) to prevent excessive evaporation. Seedlings were irrigated three times per week with 8 ml of Hoagland solution, see Hoagland et al., 1938.

Extract concentrations: the extracts were diluted as follows:
OH: 1 g in 10 ml sterile tap water (overnight shaking)->add up to 1 L sterile tap water->filter (595 1/2-70 mm).
EH: 1 g in 10 ml 70% EtOH (overnight shaking)->add up to 1 L sterile tap water->filter (595 1/2-70 mm).
EA and HE: 200 mg in 2 ml DMSO (overnight shaking)->add up to 200 mL sterile tap water->filter (595 1/2-70 mm). Before use, each of the four extracts were further diluted to 1/2, 1/10, and 1/100 concentrations.

Treatment with extract and nematode inoculation: Fourteen-day old rice plants were foliar sprayed with the DDGS extracts (7 ml/plant+0.2% Tween20 as surfactant). Control plants were treated with water+0.2% Tween20 (negative control) or with 0.2% Vertimec™ (positive control). Vertimec™ (abamectin) has a known nematocidal effect at a concentration of 0.2%, see Faske et al., 2006. Per treatment, 6 individual plants were used (n=6). One day after treatment, plants were inoculated with nematodes by introducing 250 J2 next to the root system using a micro pipette.

Evaluation: Plants were harvested 14 days after inoculation. The plants were phenotype by measuring the shoot and root length with a ruler. Root systems were then stained in acid fuchsine as described in Bybd et al., 1983, and left to distain in glycerol containing 1 ml/l fuming HCl for approximately ten days. The number of root galls formed by M. graminicola was then counted using a binocular microscope. Statistical analysis-After confirming normality and homoscedasticity of the data a Duncan's Multiple Range test was executed with α=0.05.

### Direct Nematicidal Effect

In a 12-well plate, nematodes (M. graminicola and P. zeae) were exposed to 3 different concentrations of the extracts (prepared as previously described), 0.2% Vertimec™ (positive control) or water (negative control). Per treatment, 3 repetitions were done, each with 50 nematodes. The plates were incubated on a shaker at room temperature. Nematodes were microscopically inspected 48 h after supply the extract, using a binocular microscope. In each well, the number of living and dead nematodes was counted. Living nematodes are curly and moving. Dead (or paralyzed) nematodes can be visually recognized because they are straight, and are not moving. Percentage of mortality and efficacy are calculated as follows: Mortality per well=the number of dead nematodes in a well divided by the total number of nematodes in that well.

Average mortality per treatment=average of the 3 wells×100→% mortality

Efficacy (%)=% mortality of treated nematodes-% mortality in the negative control (tap water)

### Results

In this experiment, the induced effect against root-knot nematode Melodoigyne graminicola in rice (Oryza sativa cv. Nipponbare) was evaluated by spraying the DDGS extracts on rice shoots 24 h before nematode inoculation (250 J2 per plant) on the roots. Root galls were counted 14 days later (n=6).

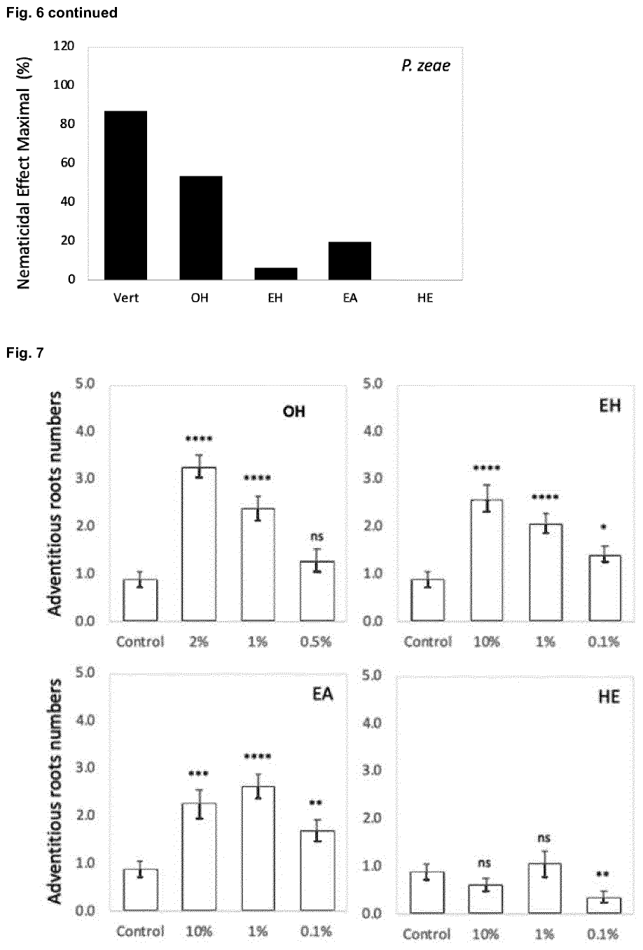

FIG. 5 illustrates rice systemic defence activation against root-knot nematodes after foliar application of DDGS extracts. Inoculation with 250 second stage juveniles of root-knot nematode Meloidogyne graminicola on the root system was done at 24 h after foliar application of the 4 DDGS extracts, of a nematicide (Vert: Vertimec™), or water control. Data was taken 2 weeks later and scored as number of galls per rice plant. Data represent the average of a minimum of six biological replicates. Error bars represent standard error. Asterisks indicate significant differences between control and treatment according to a Student's t-test (*P<0.05; ** P<0.01; *** P<0.001; **** P<0.0001; ns P>0.05). The results presented in FIG. 5 show that foliar application of the DDGS aqueous (OH) and ethanol (EH) extracts leads to significant reduction of root-knot nematodes infection (a smaller number of galls). Application of the EA and HE extracts, on the other hand, did not lead to any reduction of the number of galls. FIG. 6 illustrates in vitro growth inhibition of root-knot (M. graminicola) and migratory (P. zeae) nematodes by the 4 DDGS extracts (OH, EH, EA, HE), and by a commercial nematicide (Vertimec™: Vert). Each extract was tested at 3 different dilutions (0.1, 0.01, and 0,001). Top panel (M. graminicola) represents the nematicidal effects of dilution 0.01 and the right panel (P.zeae) represents the nematicidal effects of dilution 0.1. FIG. 6, top panel, shows that the OH and EH extracts are the most effective extracts against the same root-knot (M. graminicola) nematode. FIG. 6, bottom panel, shows that the DDGS aqueous extract was also highly effective against the migratory (P. zeae) nematode. A moderate effect against P. zeae, was also observed for the EA extract.

### Biostimulant Activity

### In-Vitro Arabidopsis ROOT Assays

### Materials and Methods

The 4 extracts were prepared as described above and incorporated in MS (Murashige and Skoog) basal medium at the concentrations indicated in Table 1.

TABLE 1
Extracts concentrations used in the root bioassays.

| | | | Concentration | | |
|---|---|---|---|---|---|
| Extract | Code | Type | High | Middle | Low |
| Aqueous extract | OH | liquid | 2% (v/v) | 1% (v/v) | 0.5% (v/v) |
| Ethanol, ethyl acetate and | EH, EA, | Solid | 10% (mg/ml) | 1% (mg/ml) | 0.1% (mg/ml) |
| hexane extract | HE | | | | |

Arabidopsis thaliana Col-0 seeds were sterilized, shown on MS petri dishes, vernalized in the dark at 5° C. for 4 days, and etiolated following an in-house developed protocol, see protocol Trinh H K et al., 2018. Etiolated seedlings were transferred to freshly prepared, treatment (MS medium with extracts) and control (MS medium without extract), petri dishes. Root morphology traits (adventitious root numbers, junction root numbers, primary root growth rate, and primary root length) were examined and recorded by digital photography after 10 days of incubation under the same light and temperature conditions.

### Results

A significantly higher density of adventitious roots, see FIG. 7, was observed on plants treated with OH, EH, and EA extracts. FIG. 7 shows biostimulant assays, more specifically the adventitious roots numbers of Arabidopsis seedlings treated with water (Control) or with 3 different doses of the 4 extracts (OH, EH, EA, HE). Data represent the average of three biological and ten technical replicates per bar (30 seedlings in total, 10 per replicate). Error bars represent standard error. Asterisks indicate significant differences between control and treatment according to a Student's t-test (*P<0.05; ** P<0.01; *** P<0.001; **** P<0.0001; ns P>0.05). OH: aqueous extract, EH: ethanol extract, EA: ethyl acetate extract, HE: hexane extract. The OH extract (0.5%) and the HE (10% and 1%) extract failed to promote the development of adventitious roots and HE at 0.1% had an inhibiting effect. OH, EH and EA extracts stimulate adventitious root numbers at all concentrations in a significant manner. Adventitious roots are commercially relevant for vegetative (instead of sexual) propagation, nutrient absorption and general improvement of plant fitness (due to better absorption of nutrients).

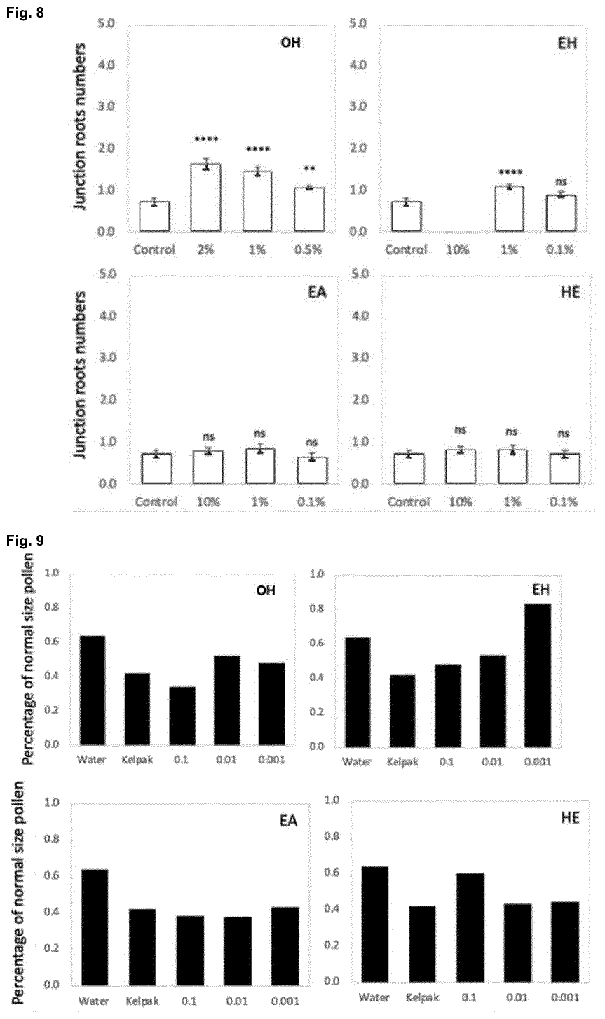

FIG. 8 shows further biostimulant assays, more specifically junction roots numbers of Arabidopsis seedlings treated with water (Control) or with 3 different doses of the 4 extracts (OH, EH, EA, HE). The number of junction roots was promoted by the OH extract (all concentrations), and the EH extract at 1%. The other 2 extracts (EA and HE) had neither promoting nor inhibiting effects on junction roots. Data represent the average of three biological and ten technical replicates per bar (30 seedlings in total, 10 per replicate). Error bars represent standard error. Asterisks indicate significant differences between control and treatment according to a Student's t-test (*P<0.05; ** P<0.01; *** P<0.001; **** P<0.0001; ns P>0.05). OH: aqueous extract, EH: ethanol extract, EA: ethyl acetate extract, HE: hexane extract. OH at all concentrations and EH (1%) show significant positive results, and therefore shows that these extracts provide biostimulant properties. The role of the junction root is the anchoring of a seedling in the soil. Usually, one such root provides sufficient fixation to the position in the soil. Additional junction roots are beneficial when the root system is damaged by waterlogging or disease. These results show that the DDGS extracts modulate root growth.

### Fertility Assays

### Materials and Methods

Arabidopsis thaliana Col-0 seeds were sterilized, shown on petri dishes containing K1 medium, and vernalized in the dark at 5° C. for 4 days. Germinated seedlings were transplanted to soil, covered with plastic film, and let to grow for 4 days in a growth chamber (16-h light, 21° C.; 8-h darkness, 18° C.), before being double treated by foliar spraying.

The first foliar spraying was applied at the early bolting stage, and the second, 3 days later. Each sprayed volume (treatment) consisted of 25 ml of solution that was applied to three independent plants. The liquid aqueous (OH) extract, was diluted to 2%, 1% and 0.5% v/v concentrations, whereas the solid extracts (EH, EA and HE) were first dissolved in 0.01% DMF and then diluted to 10%, 1% and 0.1% final concentrations, see Table 2. Water, and DMF 0.01%, and Kelpak 2% (a commercial biostimulant) were sprayed as controls.

TABLE 2
Extracts concentrations used in the fertility bioassays.

| | | | Concentration | | |
|---|---|---|---|---|---|
| Extract | Code | Type | High | Middle | Low |
| Aqueous extract | OH | liquid | 2% (v/v) | 1% (v/v) | 0.5% (v/v) |
| Ethanol extract | EH | Solid | 0.1% | 0.01% | 0.001% |
| | | | (4.17 mg/ml) | (0.417 mg/ml) | (0.0417 mg/ml) |
| Ethyl Acetate | EA | Solid | 0.1% | 0.01% | 0.001% |
| extract | | | (1.5 mg/ml) | (0.15 mg/ml) | (0.015 mg/ml) |
| Hexane extract | HE | Solid | 0.1% | 0.01% | 0.001% |
| | | | (0.083 mg/ml) | (0.0083 mg/ml) | (0.0083 mg/ml) |

### Results

FIG. 9 shows that EH at low concentration (0,001%) gives the highest score for percentage of normal size pollen. All other extract and concentrations had effects comparable to Kelpak™, a commercially available compound of reference in FIG. 9. More specifically, FIG. 9 shows percentage of normal size pollen from Arabidopsis plants treated with water (Control), with a commercial biostimulant (Kelpak™), or with 3 different doses (0.1; 0.01; 0.001) of the 4 extracts (OH, EH, EA, HE). OH: aqueous extract, EH: ethanol extract, EA: ethyl acetate extract, HE: hexane extract. In FIG. 9, only EH 0.001% has a positive effect (higher than control). All the other extracts and concentrations are equal to control (water) or Kelpak™ (a commercially available product, sold as biostimulant). The method used determines the size of about 10.000 pollen in a few minutes and the size distribution is then plotted. Extracts that would cause damage to the pollen would generate a major shift in pollen size downward. The data show that the extracts do not have gametocide activity (a drug that kills gametes, used in breeding for example). The data are in accordance with the observation that fertility is not affected.

### Growth Parameters

### Materials and Methods

The leaves of five weeks-old maize plants (Zea mays L. LG31233), and 18 days-old tomato plants (Dona hybrid F1), and two weeks-old wheat plants (cv. Gedser) were sprayed with the extracts prepared at 10% concentrations.

All plants were grown on pots with universal potting soil (Pflanzerde Potgrond Universeel-Jardino BASIC) containing 35% organic substrates, 1.5 g KCl/I and pH value of 5.8 (adjusted with CaCl2).

Growth rate was measured by measuring plant height each week after spraying, and for a total of 3 or 4 weeks. During this period plants were kept in walk-in climatized greenhouses under different light and temperature conditions. Wheat was kept at 20-22° C. and 16 h photoperiod, tomato at 18-20° C. and 12 h photoperiod, and maize at an average night/day temperature ranging from 21 to 32° C. and natural light conditions. All plants were regularly watered. A mixture of nutrient solution (including triple superphosphate (TSP) 45%, and urea-ammonium nitrate fertilizer (UAN) 39%, Patentkali 30%) was given one time (50 mL per pot) to maize plants after 3 weeks of growing.

Additionally, the chlorophyll content was measured by a SPAD chlorophyll meter, 2 and 3 weeks after spraying. Note that some extracts were not tested.

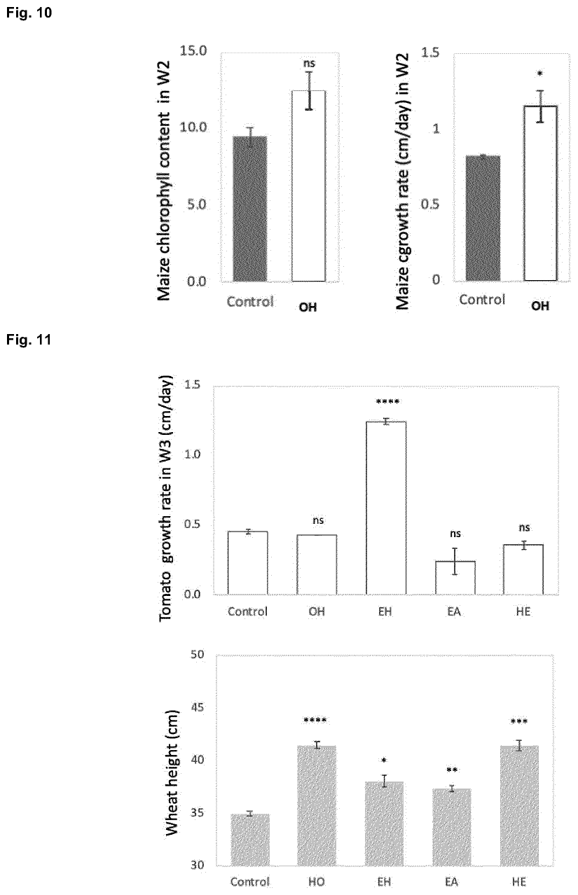

Results FIG. 10 shows chlorophyll content (left panel) and growth rate (right panel) during week 2 (W2) of maize plants, treated with water (control) or with the DDGS aqueous (OH) extract at a concentration of 10%. Data represent the average of three (control) or 4 (OH) biological replicates. Error bars represent standard error. Asterisks indicate significant differences between control and treatment according to a Student's t-test (*P<0.05; ** P<0.01; *** P<0.001; **** P<0.0001; ns P>0.05). FIG. 10 shows that the DDGS aqueous extract, applied at a concentration of 10%, was responsible for the increase of the chlorophyll content (left panel) and the growth rate (right panel) of maize plants.

FIG. 11 shows tomato growth rate (top panel) and wheat height (bottom panel) treated with water (control) or with the DDGS extracts (OH, EH, EA, HE) extracts. Data represent the average of three biological replicates. Error bars represent standard error. Asterisks indicate significant differences between control and treatment according to a Student's t-test (*P<0.05; ** P<0.01; *** P<0.001; **** P<0.0001; ns P>0.05). The growth rate of tomato plants was highly promoted by the EH extract, see FIG. 11, top panel, whereas for wheat, all four DDGS extracts had a significant plant growth promoting effect, being the OH and the HE extracts the most effective ones, FIG. 11, bottom panel).

### REFERENCES

[1] Reversat G, Boyer J, Sannier C, Pando-Bahuon A. 1999. Use of a mixture of sand and water-absorbent synthetic polymer as substrate for the xenic culturing of plant-parasitic nematodes in the laboratory. Nematology 1, 209-212.
[2] Hoagland, D. R. and Arnon, D. I. (1938) The water culture method for growing plants without soil. California Agricultural Experiment Station Circulation, 347, 32.
[3] Faske T R, Starr J L. Sensitivity of Meloidogyne incognita and Rotylenchulus reniformis to abamectin (2006). Journal of Nematology, 38:240-244.
[4] Bybd D W, Kirkpatrick T, Barker K R. An improved technique for clearing and staining plant tissues for detection of nematodes. J Nematol. 1983; 15(1):142-143.
[5] Trinh, Hoang Khai, Inge Verstraeten, and Danny Geelen. “In Vitro Assay for Induction of Adventitious Rooting on Intact Arabidopsis Hypocotyls.” Root Development: Methods and Protocols. Ed. Daniela Ristova & Elke Barbez. Vol. 1761. New York, N Y, USA: Springer Humana Press, 2018. 95-102.

1. Use of a Distillers' Dried Grains with Solubles (DDGS) extract as a biopesticide and/or biostimulant in agriculture, horticulture or arboriculture.

2. Use according to claim 1, wherein the DDGS extract is prepared by a method comprising an aqueous extraction step comprising the steps of:
a) providing DDGS;
b) mixing the DDGS of step a) with an aqueous solution, while heating said mixture;
c) separating the heated mixture of step b) into a solid phase and a liquid phase; and
d) obtaining the liquid phase of step c) as a DDGS aqueous extract.

3. The use according to claim 2, wherein the solid phase obtained in step c) is further processed by:
a) mixing said solid phase with an organic extractant;
b) separating the mixture of step a) into a solid phase and a liquid phase; and
c) obtaining the liquid phase as a DDGS organic solvent extract;
wherein optionally steps a) to c) are repeated one or more times using a different extractant.

4. The use according to claim 3, wherein said organic extractant is selected from the list comprising ethanol, ethyl acetate and hexane.

5. The use according to claim 3 or 4, wherein steps a) to c) are sequentially repeated using the following organic extractants in the specified order: ethanol, ethyl acetate and hexane.

6. The use according to claim 2, wherein the solid phase obtained in step c) is further processed by:
a) mixing said solid phase with ethanol;
b) separating the mixture of step a) into a solid phase and a liquid phase; and
c) obtaining the liquid phase as a DDGS ethanol extract.

7. The use according to claim 6, wherein the solid phase obtained in step b) is further processed by:
a) mixing said solid phase with ethyl acetate;
b) separating the mixture of step a) into a solid phase and a liquid phase; and
c) obtaining the liquid phase as a DDGS ethyl acetate extract.

8. The use according to claim 7, wherein the solid phase obtained in step b) is further processed by:
a) mixing said solid phase with hexane;
b) separating the mixture of step a) into a solid phase and a liquid phase; and
c) obtaining the liquid phase as a DDGS hexane extract.

9. The use according to any one of claims 3 to 8 wherein said DDGS organic solvent extract is further subjected to an evaporation step.

10. The use according to any one of claims 2 to 9, wherein said heating is performed at a temperature in a range from about 30° C. to about 120° C., preferably from 50° C. to 100° C., preferably from 60° C. to 90° C., more preferably at a temperature of about 80° C. and/or for a sustained period of time, in a range from about 5 min to about 180 min, preferably from 10 min to 150 min, preferably from 50 min to 130 min, more preferably about 120 min.

11. The use according to any one of claims 1 to 10, wherein said DDGS is provided in powder form.

12. The use according to claim 1, wherein said DDGS extract is selected from the list comprising: a DDGS aqueous extract, a DDGS ethanol extract, a DDGS ethyl acetate extract and a DDGS hexane extract; preferably a DDGS aqueous extract or a DDGS ethanol extract.

13. The use according to any one of claims 1 to 12, wherein the extract is applied on a plant or part(s) thereof, or in the growth medium of a plant.

14. The use according to any one of claims 1 to 13, wherein the extract is applied to the leaves, stems, roots, seeds, plant cells and progeny of a plant or to the soil or substrate surrounding the plant.

15. The use according to any one of claims 1 to 13, wherein the extract is sprayed on the plant, watered on the plant, or added to the soil or substrate in which the plant is growing.

16. The use according to any one of claims 1 to 15, wherein the extract induces (systemic) resistance to biotic stress in a plant, in particular to an infection with a plant pathogen.

17. The use according to claim 16, wherein the plant pathogen is selected from bacteria, fungi, nematodes and oomycetes.

18. The use according to claim 17, wherein the bacteria are phytopathogenic bacteria selected from the group consisting of Pseudomonas, Ralstonia, Rhizobium, Agrobacterium, Xanthomonas, Erwinia, Xylella, Dickeya, Pectobacterium, Streptomyces, Clavibacter, Candidatus Liberibacter, Bacillus, Corynebacterium and Burkholderia.

19. The use according to claim 17, wherein the fungi are phytopathogenic fungi selected from the group consisting of Magnaporthe, Botrytis, Puccinia, Fusarium, Blumeria, Mycosphaerella, Colletotrichum, Ustilago, Phakopsora, Alternaria, Sclerotinia, Cladosporium and Rhizoctonia.

20. The use according to claim 17, wherein the nematodes are phytopathogenic nematodes selected from the group consisting of Meloidogyne, Heterodera, Globodera, Pratylenchus, Aphelenchoides, Xiphinema, Radopholus, Bursaphelenchus, Rotylenchulus, Nacobbus, Longidorus, Ditylenchus and Trichodorus.

21. The use according to claim 17, wherein the oomycetes are phytopathogenic oomycetes selected from the group consisting of Pythium, Phytophtora and Peronosporaceae.
